(19) United States
(12) Patent Application Publication
(10) Pub. No.: US 2015/0303611 A1
(43) Pub. Date: Oct. 22, 2015

(54) SHIELDED CONNECTOR

(71) Applicant: YAZAKI CORPORATION, Minato-ku,Tokyo (JP)

(72) Inventor: Hayato IIZUKA, Shizuoka (JP)

(73) Assignee: YAZAKI CORPORATION, Minato-ku, Tokyo (JP)

(21) Appl. No.: 14/440,884

(22) PCT Filed: Oct. 22, 2013
(86) PCT No.: PCT/JP2013/078548

§ 371 Date: May 6, 2015

(30) Foreign Application Priority Data
Nov. 15, 2012 (JP) 2012-250864

(51) Int. Cl. H01R 13/52; H01R 13/6581

(52) U.S. Cl. CPC H01R 13/5202; H01R 13/6581

(57) ABSTRACT

A shielded connector (1, 101, 201, 301) includes a shield shell (5) having a cylindrical portion (3), a cylindrical shield member (7) arranged at an inner circumference side of the cylindrical portion (3), and a pressing member (9, 103, 203, 303) arranged at the inner circumference side of the cylindrical portion (3) across the shield member (7). The pressing member (9, 103, 203, 303) presses an end portion of the shield member (7) toward the cylindrical portion (3) and fixes the shield member (7) to the cylindrical portion (3) in close contact with each other.

### TECHNICAL FIELD

The present invention relates to a shielded connector.

### BACKGROUND ART

Patent Literature 1 discloses a shielded connector which includes a metal housing as a shield shell including a cylindrical portion, and a cylindrical shield member arranged at the cylindrical portion.

According to this shielded connector, an outer circumference of a terminal housing is covered by the shield member, an outer circumference of this shield member is covered by the cylindrical portion of the metal housing, and the metal housing is bolted to a shield case.

By bolting the metal housing to the shield case in this way, a front end portion of the shield member is clamped by the terminal housing and the metal housing, so that the shield member is held.

### CITATION LIST

### Patent Literature

Patent Literature 1: Japanese Unexamined Patent Application Publication No. 2008-235190

### SUMMARY OF INVENTION

The shielded connector according to Patent Literature 1 adopts a configuration in which an end portion of a shield member is sandwiched by a terminal housing and a metal housing as a shield shell. Therefore, a gap is likely to be formed at a contact region of the shield shell and the shield member, and it is difficult to apply waterproof treatment therebetween.

In addition, the shield member is held by bolting the shield shell to the shield case. Therefore, contact reliability between the shield shell and the shield member is managed by bolting indirect other portions, and therefore it is difficult to secure the contact reliability.

An object of the present invention is to provide a shielded connector which can easily apply waterproof treatment between a shield shell and a shield member, and secure contact reliability between the shield shell and the shield member.

A shielded connector in accordance with some embodiments includes a shield shell having a cylindrical portion, a cylindrical shield member arranged at an inner circumference side of the cylindrical portion, and a pressing member arranged at the inner circumference side of the cylindrical portion across the shield member. The pressing member presses an end portion of the shield member toward the cylindrical portion and fixes the shield member to the cylindrical portion in close contact with each other.

According to the above configuration, the end portion of the shield member is sandwiched by the cylindrical portion and the pressing member inserted in the cylindrical portion, and is fixed in close contact with the cylindrical portion. Consequently, a gap is not formed at a contact region of the shield shell and the shield member.

Further, the shield member is pressed by the pressing member inserted in the cylindrical portion of the shield shell, and is fixed by being sandwiched between the pressing member and the cylindrical portion. Consequently, it is possible to directly manage the contact reliability between the shield shell and the shield member.

Consequently, according to the shielded connector, by arranging the pressing member at the end portion of the shield member, it is possible to easily apply waterproof treatment between the shield shell and the shield member, and secure the contact reliability between the shield shell and the shield member.

The shield member may have a folded portion at which the end portion of the shield member is folded back toward an outer circumference of the shield member, and the pressing member may be arranged at the folded portion.

According to the above configuration, the pressing member is arranged at the folded portion at which the end portion of the shield member is folded toward the outer circumference. Consequently, it is possible to prevent the shield member from dropping out of the cylindrical portion of the shield shell.

The shielded connector may further include a fixing member arranged at the outer circumference of the shield member, fixed to an inner circumference of the cylindrical portion, and pressing the pressing member, and the pressing member may press the shield member toward the cylindrical portion by being pressed by the fixing member.

According to the above configuration, the pressing member is pressed by the fixing member fixed to the cylindrical portion, and presses the shield member toward the cylindrical portion. Consequently, the fixing member can increase a pressing force of the pressing member, and secure waterproof performance and the contact reliability. In addition, the fixing member can prevent the pressing member from being displaced.

### BRIEF DESCRIPTION OF DRAWINGS

FIG. 1 is a perspective view of a shielded connector according to a first embodiment of the present invention.

FIG. 2 is a cross-sectional view of the shielded connector according to the first embodiment of the present invention.

FIG. 3 is a perspective view of a shielded connector according to a second embodiment of the present invention.

FIG. 4 is a cross-sectional view of the shielded connector according to the second embodiment of the present invention.

FIG. 5 is a schematic view of a shielded connector according to a third embodiment of the present invention before a pressing member is assembled thereto.

FIG. 6 is a schematic view of the shielded connector according to the third embodiment of the present invention when the pressing member is assembled thereto.

FIG. 7 is a cross-sectional view of the shielded connector according to a fourth embodiment of the present invention.

### DESCRIPTION OF EMBODIMENTS

A waterproof connector according to embodiments of the present invention will be described with reference to FIGS. 1 to 7.

### First Embodiment

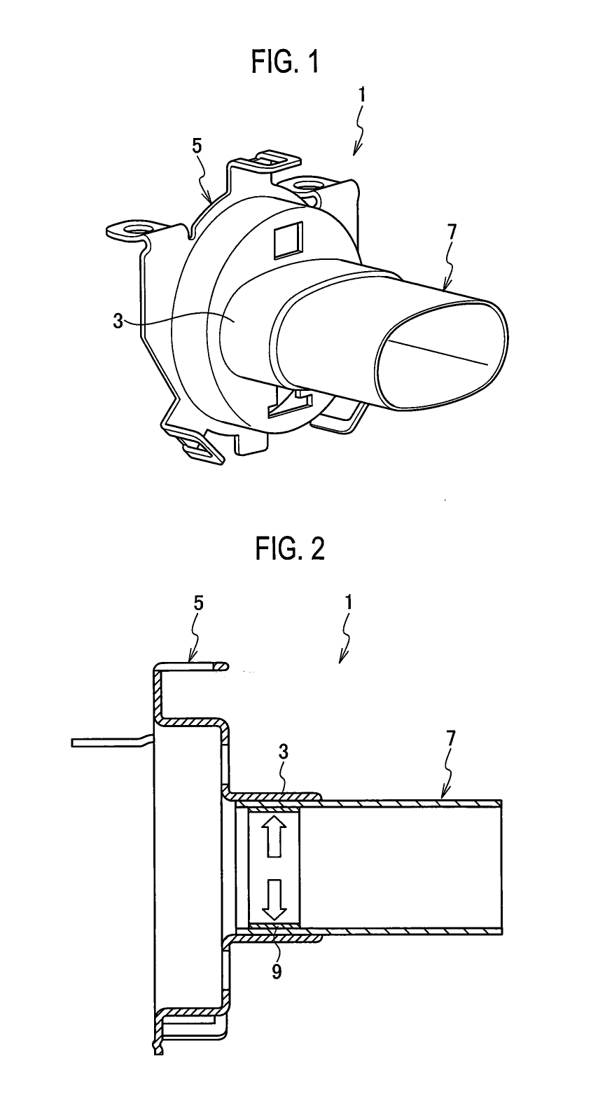

A first embodiment will be described with references to FIGS. 1 and 2.

A shielded connector 1 according to the present embodiment includes a shield shell 5 including a cylindrical portion 3, and a cylindrical shield member 7 arranged at the cylindrical portion 3.

Further, in the cylindrical portion 3, the shield member 7 is inserted in an inner circumference side, and an end portion of the shield member 7 is sandwiched and fixed between the cylindrical portion 3 and a pressing member 9 inserted in the cylindrical portion 3.

Further, the pressing member 9 presses the shield member 7 toward the cylindrical portion 3, and fixes the shield member 7 in close contact with the cylindrical portion 3. More specifically, the pressing member 9 includes a crimping ring which crimps the shield member 7 toward an inner circumference surface of the cylindrical portion 3.

In this regard, the shielded connector 1 is assembled to a wire lead-out portion side of a housing which is not illustrated and in which a terminal connected to end portions of wires is housed. By covering, with the shielded connector 1, the outer circumferences of the wires led out from this housing, it is possible to prevent noise from intruding therein or leaking therefrom. Hereinbelow, this shielded connector 1 will be described.

As illustrated in FIGS. 1 and 2, the shielded connector 1 includes the shield shell 5, the shield member 7 and the pressing member 9.

The shield shell 5 is made of a conductive material, and is assembled to the wire lead-out portion side of the housing. Further, the shield shell 5 is provided with the cylindrical portion 3 in which the wires are inserted. The shield member is arranged at the inner circumference side of this cylindrical portion 3.

The shield member 7 is made of a conductive metal foil formed into a sheet shape, and is formed into a cylindrical shape. Further, the shield member 7 is inserted in the inner circumference of the cylindrical portion 3 of the shield shell 5, and covers the outer circumferences of the wires led from the housing.

This shield member 7 is electrically connected to the shield shell 5 to form a shield circuit which prevents noise from intruding in or leaking from the wires. This shield member 7 is fixed to the cylindrical portion 3 of the shield shell 5 by the pressing member 9.

The pressing member 9 includes the crimping ring which is formed into an annular shape and whose diameter can be expanded, and is inserted in the inner circumference of the end portion of the shield member 7. In a state where the shield member 7 is inserted in the cylindrical portion 3 of the shield shell 5, this pressing member 9 is crimped such that the diameter of the pressing member 9 expands toward the inner circumference surface of the cylindrical portion 3 by a jig (not illustrated) as indicated by an arrow in FIG. 2, presses the shield member toward the cylindrical portion 3, and fixes the outer circumference surface of the shield member 7 in close contact with the inner circumference surface of the cylindrical portion 3.

Crimping the pressing member 9 in this way conducts the shield shell 5 and the shield member 7 to form the shield circuit. This shield circuit is formed at the inner circumference side of the cylindrical portion 3, so that it is possible to enhance shielding performance against noise compared to a case where the shield case is formed at the outer circumference side of the cylindrical portion 3.

Further, the shield shell 5 and the shield member 7 are placed in direct contact by the pressing member 9 instead of being placed in indirect contact by bolting other parts. Consequently, it is possible to improve contact reliability between the shield shell 5 and the shield member 7.

Further, a contact region at which the shield shell 5 and the shield member 7 are placed in contact by the pressing member is positioned at the inner circumference side of the cylindrical portion 3, and is inclose contact with the pressing member 9. Consequently, it is possible to reduce a chance of contact with water, prevent a gap from being formed between the shield shell 5 and the shield member 7, and improve waterproof performance and corrosion resistance.

According to this shielded connector 1, the end portion of the shield member 7 is sandwiched and fixed between the cylindrical portion 3 and the pressing member 9 inserted in the cylindrical portion 3. More specifically, the pressing member 9 which presses the shield member 7 toward the cylindrical portion 3, and fixes the shield member 7 in close contact with the cylindrical portion 3 is arranged at the end portion of the shield member 7. Consequently, a gap is not formed at the contact region of the shield shell 5 and the shield member 7.

Further, the shield member 7 is sandwiched and fixed between the pressing member 9 inserted in the cylindrical portion 3 of the shield shell 5, and the cylindrical portion 3 by the pressing member 9. More specifically, the pressing member 9 fixes the shield member 7 in close contact with the cylindrical portion 3 of the shield shell 5. Consequently, it is possible to directly manage the contact reliability between the shield shell 5 and the shield member 7.

Consequently, according to this shielded connector 1, by arranging the pressing member 9 at the end portion of the shield member 7, it is possible to easily apply waterproof treatment between the shield shell 5 and the shield member 7 and secure the contact reliability between the shield shell 5 and the shield member 7.

Further, the pressing member 9 includes the crimping ring which crimps the shield member 7 toward the inner circumference surface of the cylindrical portion 3. Consequently, it is possible to apply waterproof treatment with a simple configuration, and secure the contact reliability.

### Second Embodiment

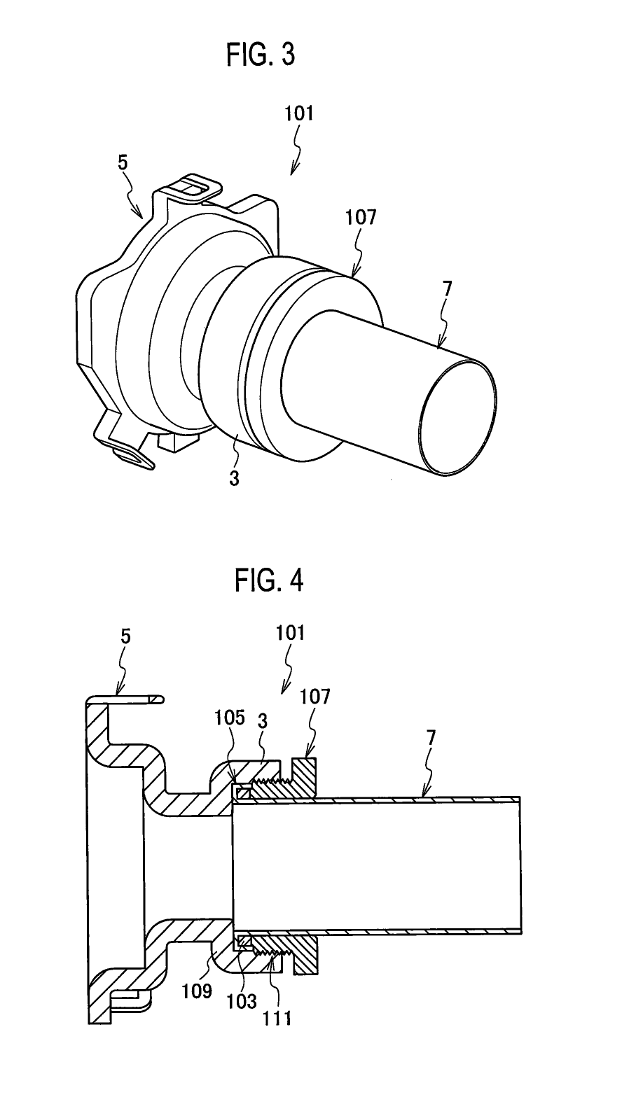

A second embodiment will be described with references to FIGS. 3 and 4.

In a shielded connector 101 according to the present embodiment, a pressing member 103 is arranged at a folded portion 105 at which an end portion of a shield member 7 is folded back toward the outer circumference.

Further, a fixing member 107 fixed to an inner circumference of a cylindrical portion 3 is arranged on an outer circumference of the shield member 7, and the pressing member 103 presses the shield member 7 toward the cylindrical portion 3 by being pressed by the fixing member 107.

Furthermore, the pressing member 103 includes a rubber seal as an elastic member which presses the shield member 7 toward an inner circumference surface of the cylindrical portion 3.

Note that the same configurations as those in the first embodiment will be assigned the same reference numerals, and a configuration and a function will not be described assuming that a reference to the first embodiment will be made. The configuration is the same as that of the first embodiment, so that a resulting effect is the same.

As illustrated in FIGS. 3 and 4, the diameter of an opening side of the cylindrical portion 3 of the shield shell 5 is formed larger than the diameter of a base portion side, and a step portion 109 is formed at the base portion side. An end surface of the folded portion 105 provided at the end portion of the shield member 7 is in contact with a sidewall of this step portion 109.

The folded portion 105 of the shield member 7 is formed by folding the end portion of the shield member 7 a predetermined length toward the outer circumference. In this folded portion 105, the pressing member 103 is arranged.

The pressing member 103 is the rubber seal as the elastic member which is formed in an annular shape and can be elastically deformed. The pressing member 103 is arranged at the folded portion 105 such that a surrounding of the pressing member 103 is covered by the folded portion 105. In a state where the shield member 7 is inserted in the cylindrical portion 3 of the shield shell 5, this pressing member 103 presses the folded portion 105 of the shield member 7 toward the cylindrical portion 3 while a side surface of the opening side is pressed by the fixing member 107 fixed to the cylindrical portion 3, and fixes the outer circumference surface of the folded portion 105 in close contact with the inner circumference surface of the cylindrical portion 3.

The fixing member 107 is formed in an annular shape, and is fastened and fixed to the cylindrical portion 3 through a screw portion 111 formed between the outer circumference surface and the inner circumference surface of the cylindrical portion 3. This fixing member 107 presses the pressing member 103 between the fixing member 107 and the sidewall surface of the step portion 109 by being fastened to the screw portion 111, elastically deforms the pressing member 103, and fixes the shield shell 5 and the shield member 7 in close contact with each other.

Pressing the pressing member 103 in this way conducts the shield shell 5 and shield member 7 to form a shield circuit. In this regard, the rubber seal as the pressing member 103 is arranged between the shield shell 5 and the fixing member 107. Consequently, it is possible to reliably apply waterproof treatment between the shield shell 5 and the fixing member 107.

Further, the pressing member 103 is arranged in the folded portion 105 of the shield member 7. Consequently, it is possible to enhance the rigidity against a load applied to the shield member 7 in a direction in which the shield member 7 drops out of the cylindrical portion 3.

According to this shielded connector 101, the pressing member 103 is arranged at the folded portion 105 at which the end portion of the shield member 7 is folded toward the outer circumference. Consequently, it is possible to prevent the shield member 7 from dropping out of the cylindrical portion 3 of the shield shell 5.

Further, the pressing member 103 presses the shield member 7 toward the cylindrical portion 3 by being pressed by the fixing member 107 fixed to the cylindrical portion 3. Consequently, the fixing member 107 can increase a pressing force of the pressing member 103, and it is possible to secure waterproof performance and contact reliability more. In addition, the fixing member 107 can prevent the pressing member 103 from being displaced.

Further, the pressing member 103 is the rubber seal as the elastic member which presses the shield member 7 toward the inner circumference surface of the cylindrical portion 3. Consequently, it is possible to reliably apply waterproof treatment between the shield shell 5 and the fixing member 107.

### Third Embodiment

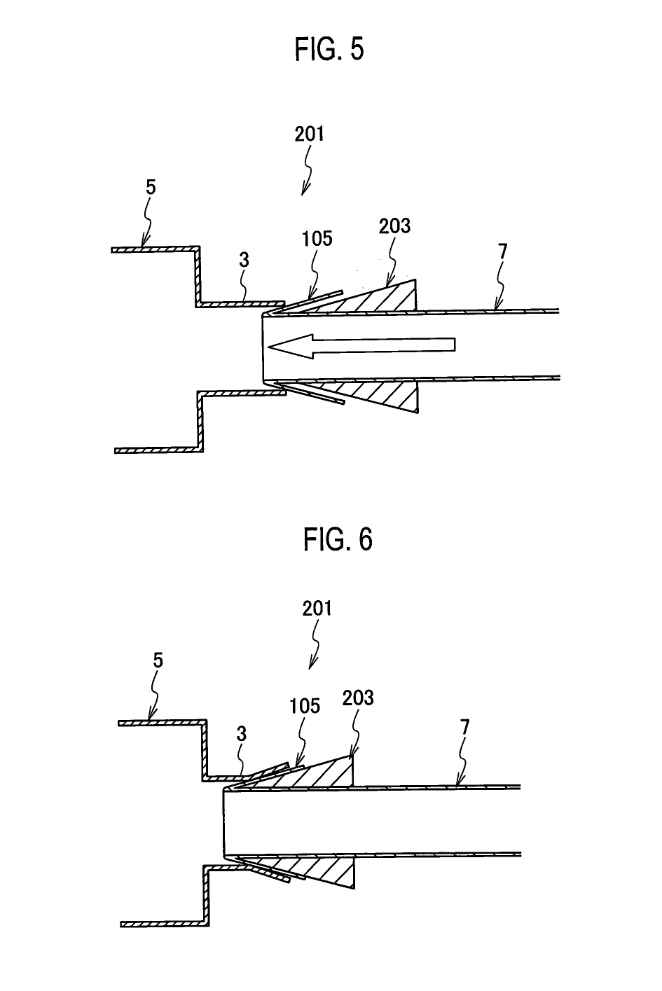

A third embodiment will be described with reference to FIGS. 5 and 6.

According to a shielded connector 201 according to the present embodiment, a pressing member 203 is arranged at a folded portion 105 at which an end portion of a shield member 7 is folded toward the outer circumference.

Further, the pressing member 203 is a wedge-shaped bush which presses the shield member 7 toward an inner circumference surface of a cylindrical portion 3 by being pressed fit to the cylindrical portion 3.

Note that the same configurations as those in the other embodiments will be assigned the same reference numerals, and a configuration and a function will not be described assuming that a reference to the other embodiments will be made. The configuration is the same as that of the other embodiments, so that a resulting effect is the same.

As illustrated in FIGS. 5 and 6, the pressing member 203 is the bush which is formed into an annular and tapered wedge. The pressing member 203 is arranged at the folded portion 105 such that a surrounding of the pressing member 203 is covered by the folded portion 105, and is pressed fit to the cylindrical portion 3.

In a state where a folded portion 105 side of the shield member 7 is inserted a predetermined length in the cylindrical portion 3 of a shield shell 5, this pressing member 203 is pressed fit to the cylindrical portion 3 by being inserted toward an inside of the folded portion 105 as indicated by an arrow in FIG. 5, presses the folded portion 105 of the shield member 7 toward the cylindrical portion 3, and fixes an outer circumference surface of the folded portion 105 in close contact with an inner circumference surface of the cylindrical portion 3.

Pressing the pressing member 203 in this way conducts the shield shell 5 and the shield member 7 to form a shield circuit. In this regard, the bush as the pressing member 203 is arranged between the shield shell 5 and the shield member 7. Consequently, it is possible to reliably apply waterproof treatment between the shield shell 5 and the shield member 7.

Further, the pressing member 203 is arranged in the folded portion 105 of the shield member 7. Consequently, it is possible to enhance the rigidity against a load applied to the shield member 7 in a direction in which the shield member 7 drops out of the cylindrical portion 3.

Furthermore, the pressing member 203 is pressed fit to the cylindrical portion 3 of the shield shell 5. Consequently, it is not necessary to use a member such as a fixing member 107 (see FIG. 4), and it is possible to reduce the number of parts and improve efficiency in assembly.

According to this shielded connector 201, the pressing member 203 is arranged at the folded portion 105 at which the end portion of the shield member 7 is folded toward the outer circumference side. Consequently, it is possible to prevent the shield member 7 from dropping out of the cylindrical portion 3 of the shield shell 5.

Further, the pressing member 203 is the wedge-shaped bush which presses the shield member 7 toward the inner circumference surface of the cylindrical portion 3 by being pressed fit to the cylindrical portion 3. Consequently, it is possible to reduce the number of parts and improve efficiency in assembly while securing waterproof performance and contact reliability.

### Fourth Embodiment

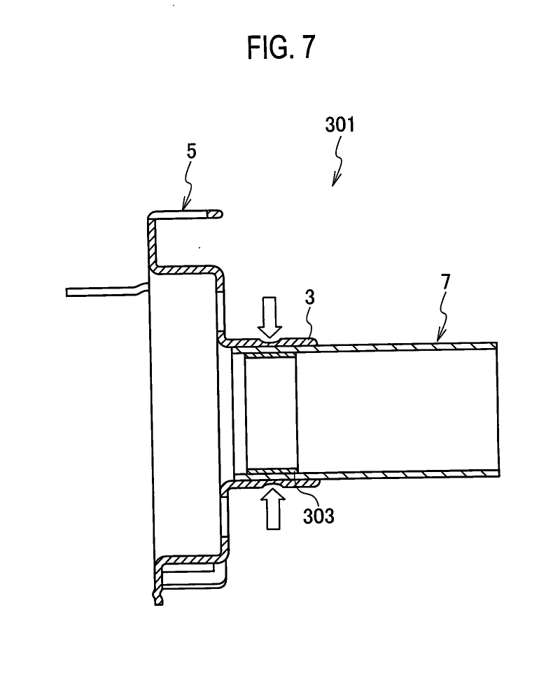

A fourth embodiment will be described with reference to FIG. 7.

According to a shielded connector 301 according to the present embodiment, a pressing member 303 is inserted in a cylindrical portion 3 of a shield shell 5, an end portion of a shield member 7 is arranged between the cylindrical portion 3 and the pressing member 303, and, by crimping the cylindrical portion 3 toward the pressing member 303, the shield member 7 is sandwiched and fixed in close contact between the cylindrical portion 3 and the pressing member 303.

Note that the same configurations as those in the first embodiment will be assigned the same reference numerals, and a configuration and a function will not be described assuming that a reference to the first embodiment will be made. The configuration is the same as that of the first embodiment, so that a resulting effect is the same.

The pressing member 303 is a member which is formed in an annular shape and has a reaction force against an external force applied from an outer circumference side to an inner circumference side, and is inserted in an inner circumference of the end portion of the shield member 7, such that the end portion of the shield member 7 is arranged between the cylindrical portion 3 and the pressing member 303.

In a state where the shield member 7 is inserted in the cylindrical portion 3 of the shield shell 5, this pressing member 303 presses the shield member 7 toward a cylindrical portion 3 side by a reaction force produced by crimping the cylindrical portion 3 toward the pressing member 303 by a jig (not illustrated) or the like as indicated by an arrow in FIG. 7, and fixes an outer circumference surface of the shield member 7 in close contact with an inner circumference surface of the cylindrical portion 3.

Crimping the cylindrical portion 3 of the shield shell 5 in this way conducts the shield shell 5 and the shield member 7 to form a shield circuit. This shield circuit is formed at the inner circumference side of the cylindrical portion 3, so that it is possible to enhance shielding performance against noise compared to a case where the shield circuit is formed at the outer circumference side of the cylindrical portion 3.

Further, instead of being placed in indirect contact by bolting other portion, the shield shell 5 and the shield member 7 are placed indirect contact by a reaction force of the pressing member 303 produced by crimping the cylindrical portion 3. Consequently, it is possible to improve contact reliability between the shield shell 5 and the shield member 7.

Further, a contact region at which the shield shell 5 and the shield member 7 are placed in contact by the reaction force of the pressing member 303 is positioned at the inner circumference side of the cylindrical portion 3 and is in close contact with the pressing member 303. Consequently, it is possible to reduce a chance of contact with water, prevent a gap from being formed between the shield shell 5 and the shield member 7 and improve waterproof performance and corrosion resistance.

According to this shielded connector 301, the end portion of the shield member 7 is arranged between the cylindrical portion 3 and the pressing member 303, the shield member 7 is sandwiched and fixed in close contact between the cylindrical portion 3 and the pressing member 303 by crimping the cylindrical portion 3 toward the pressing member 303. Consequently, a gap is not formed at the contact region of the shield shell 5 and the shield member 7.

Further, the shield member 7 is fixed in close contact with the cylindrical portion 3 of the shield shell 5 by the reaction force of the pressing member 303 produced by crimping the cylindrical portion 3. Consequently, it is possible to directly manage contact reliability between the shield shell 5 and the shield member 7.

Consequently, according to this shielded connector 301, by arranging the pressing member 303 at the end portion of the shield member 7, it is possible to easily apply waterproof treatment between the shield shell 5 and the shield member 7, and secure the contact reliability between the shield shell 5 and the shield member 7.

Note that, in the shielded connector according to the embodiments of the present invention, the shield member is a conductive metal foil formed into a sheet shape. However, the shield member is not limited to this, and may be a braided conductor formed into a knitted stitch shape.

Further, the crimping ring as the pressing member is inserted in the inner circumference side of the shield member. However, the crimping ring is not limited to this, and may be arranged at the folded portion of the shield member and crimped toward the inner circumference surface of the cylindrical portion.

Further, the cylindrical portion of the shield shell and the fixing member are fixed by way of screwing. However, the fixing method is not limited to this, and may adopt any mode such as concavo-convex engagement and adhesion, spline coupling and adhesion or pressing-fit of the fixing member to the cylindrical portion as long as the fixing member can be fixed to the cylindrical portion and the fixing member can press the pressing member.

Further, the pressing member is not limited to the crimping ring, the rubber seal and the bush, and may be any member as long as the member can seal between the shield shell and the shield member or between the shield shell and the fixing member.

In this way, the present invention includes various embodiments not described above. Therefore, the scope of the present invention is determined only by the invention identification matters according to claims reasonable from the foregoing description.

The entire content of Japanese Patent Application No. 2012-250864 (filing date: Nov. 15, 2012) is incorporated herein by reference.

1. A shielded connector comprising:
a shield shell comprising a cylindrical portion;
a cylindrical shield member arranged at an inner circumference side of the cylindrical portion; and
a pressing member arranged at the inner circumference side of the cylindrical portion across the shield member, the pressing member pressing an end portion of the shield member toward the cylindrical portion and fixing the shield member to the cylindrical portion in close contact with each other.

2. The shielded connector according to claim 1, wherein
the shield member comprises a folded portion at which the end portion of the shield member is folded back toward an outer circumference of the shield member, and
the pressing member is arranged at the folded portion.

3. The shielded connector according to claim 2, further comprising a fixing member arranged at the outer circumference of the shield member, fixed to an inner circumference of the cylindrical portion, and pressing the pressing member,
wherein the pressing member presses the shield member toward the cylindrical portion by being pressed by the fixing member.
